(19) United States
(12) Patent Application Publication
(10) Pub. No.: US 2026/0164344 A1
(43) Pub. Date: Jun. 11, 2026

(54) METHOD AND SYSTEM FOR DETERMINING ENERGY EFFICIENCY OF NETWORK SLICE BASED ON RELIABILITY IN WIRELESS COMMUNICATION SYSTEM

(71) Applicant: Samsung Electronics Co., Ltd., Gyeonggi-do (KR)

(72) Inventors: Ashutosh KAUSHIK, Bangalore (IN); Deepanshu GAUTAM, Bangalore (IN)

(21) Appl. No.: 18/706,988

(22) PCT Filed: Nov. 3, 2022
(86) PCT No.: PCT/KR2022/017169

§ 371 Date: May 2, 2024

(30) Foreign Application Priority Data
Nov. 3, 2021 (IN) 202141050592
Sep. 26, 2022 (IN) 202141050592

(51) Int. Cl. H04W 48/18; H04L 41/5009; H04W 92/18

(52) U.S. Cl. CPC H04W 48/18; H04L 41/5009; H04W 92/18

(57) ABSTRACT

The disclosure relates to a 5G or 6G communication system for supporting a higher data transmission rate. Specifically, the disclosure related to method for determining an energy efficiency of an Ultra-Reliable Low Latency Communications (URLLC) network slice based on reliability. The method includes determining, by a producer server (100), a Packet Success Rate (PSR) for one or more network interfaces in an Uplink (UL) direction(s) and/or a Down Link (DL) direction(s) for a given time period constraint, and a Mean Time Between Failures (MTBF). Further, the method includes determining, by the producer server (100), a reliability of the URLLC network slice based on the PSR and/or the MTBF. Further, the method includes determining, by the producer server (100), the energy efficiency of the URLLC network slice based on the reliability of the URLLC network slice.

### PRIORITY

This application is a National Phase Entry of PCT International Application No. PCT/KR2022/017169, which was filed on Nov. 3, 2022, and claims priority to Indian Patent Application No. 202141050592, which was filed on Sep. 26, 2022, and Indian Provisional Patent Application No. 202141050592, which was filed on Nov. 3, 2021, the entire content of each of which is incorporated herein by reference.

### TECHNICAL FIELD

The present disclosure relates to a communication network, and more specifically related to a method and a system for determining an energy efficiency of an Ultra-Reliable Low Latency Communications (URLLC) network slice based on reliability.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to wireless communication systems and, more specifically, the present disclosure relates to a method and apparatus to determine an energy efficiency of an Ultra Reliable Low Latency Communications (URLLC) network slick based on reliability in a wireless communication system.

### Solution to Problem

An embodiment herein is to provide a method and apparatus for determining an energy efficiency of an Ultra-Reliable Low Latency Communications (URLLC) network slice based on reliability. The method includes determining, by a producer server, a Packet Success Rate (PSR) for one or more network interfaces in an Uplink (UL) direction(s) and/or a Down Link (DL) direction(s) for a given time period constraint, and/or a Mean Time Between Failures (MTBF) in a network (i.e., mean time period for which service/slice remains available before it becomes unavailable, as per S-NSSAI sub-counter). Further, the method includes determining, by the producer server, a reliability of the URLLC network slice based on the PSR and/or the MTBF. Further, the method includes determining, by the producer server, the energy efficiency of the URLLC network slice based on the reliability of the URLLC network slice.

In an embodiment, where determining the PSR for one or more network interfaces in the UL direction and/or the DL direction for the time period constraint by one or more, determining, by the producer server, the PSR over a Uu Interface in the DL direction for a split gNodeB and/or the UL direction for a non-split gNB, and/or the DL direction for the non-split gNB; determining, by the producer server, the PSR over a F1-U Interface in the UL direction and/or the DL direction for the split gNB; determining, by the producer server, the PSR over the Uu interface including a gNodeB Centralized Unit (gNB-CU), the F1-U interface in the UL direction for the split gNB; determining, by the producer server, a number of outgoing GPRS Tunnelling Protocol (GTP) data packets on an N3 interface from a User Plane Function (UPF) per Single-Network Slice Selection Assistance Information (S-NSSAI) sub-counter; determining, by the producer server, a number of incoming GTP data packets loss on an N3 interface in the gNB (split or non-split gNB) per the S-NSSAI sub-counter; determining, by the producer server, a number of incoming GTP data packets loss on the N3 interface in the UPF per the S-NSSAI sub-counter; determining by the producer server, a number of GTP data packets on the N3 interface which have been accepted and successfully processed by the GTP-U protocol entity in the UPF per the S-NSSAI sub-counter; determining, by the producer server, a number of octets of GTP data packets which are not successfully received at the gNB over the N3 interface after being transmitted by the UPF per the S-NSSAI sub-counter; and determining, by the producer server, a number of octets of GTP data packets loss on the N3 interface in the UPF per the S-NSSAI sub-counter.

In an embodiment, wherein the producer server determines the average MTBF of the URLLC network slice/service that indicates a time period wherein the URLLC network slice/service remains available before becoming unavailable as a per S-NSSAI sub-counter.

In an embodiment, where determining, by the producer server, the reliability of the URLLC network slice based on the PSR and/or the MTBF includes determining, by the producer server, the PSR and/or the MTBF to determine the reliability of the URLLC network slice based on a type of service and/or a type of a slice of the network; performing, by the producer server, determining the reliability of the URLLC network slice based on the determined PSR, and/or determining the reliability of the URLLC network slice based on the determined MTBF, or determining the reliability of the URLLC network slice based on the determined PSR and the determined MTBF.

In an embodiment, where determining, by the producer server, the energy efficiency of the URLLC network slice based on the reliability includes determining, by the producer server, a total amount of energy consumption of the URLLC network slice for the given time period constraint; and determining, by the producer server, the energy efficiency of the URLLC network slice based on the reliability and the total amount of energy consumption.

In an embodiment, where the method includes receiving, by the producer server, a create Manage Object Instance (MOI) request message from a consumer server to create the MOI for perfMetricJob IOC, where the for perfMetricJob IOC includes a Key Performance Indicators (KPI) for energy efficiency of the URLLC network slice based on the reliability of the URLLC network slice; sending, by the producer server, a measurement collection request to a Network Function (NF) server in response to receiving the create MOI request message from the consumer server; and receiving, by the producer server, measurement information from the NF server to determine the PSR and/or the MTBF.

In an embodiment, where the method includes creating, by the producer server, a report based on the determined energy efficiency of the URLLC network slice; and sending, by the producer server, the report to the consumer server by a file and/or a stream of data, where the consumer server optimizes one or more URLLC network slice for the energy efficiency by utilizing the received report.

In an embodiment, where the method includes sending, by the consumer server, the create MOI request message to the producer server, where the message indicates the request to create the MOI; receiving, by the consumer server, a response message from the producer server in response to sending the create MOI request message; receiving, by the consumer server, the report from the producer server by the file and/or the stream data; and optimizing, by the consumer server, the URLLC network slice for the energy efficiency by utilizing the received report.

Accordingly, the embodiment herein is to provide a method for optimizing the URLLC network slice for the energy efficiency. The method includes sending, by the consumer server, the create MOI request message to the producer server, where the message indicates the request to create the MOI. Further, the method includes receiving, by the consumer server, the response message from the producer server in response to sending the create MOI request message. Further, the method includes receiving, by the consumer server, the report from the producer server by the file and/or the stream data, where the report includes the energy efficiency of the URLLC network slice based on the reliability. Further, the method includes optimizing, by the consumer server, the URLLC network slice for the energy efficiency by utilizing the received report.

Accordingly, the embodiments herein provide the producer server for determining the energy efficiency of the URLLC network slice based on the reliability. The producer server includes a URLLC network slice controller coupled with a processor and a memory. The URLLC network slice controller determines the PSR for one or more network interfaces in the UL direction(s) and/or the DL direction(s) for the given time period constraint, and/or the MTBF. Further, the URLLC network slice controller determines the reliability of the URLLC network slice based on the PSR and/or the MTBF. Further, the URLLC network slice controller determines the energy efficiency of the URLLC network slice based on the reliability of the URLLC network slice.

Accordingly, the embodiments herein provide the consumer server for optimizing the URLLC network slice based on the energy efficiency. The producer server includes a URLLC network slice controller coupled with a processor and a memory. The URLLC network slice controller sends the create MOI request message to the producer server to create the MOI. Further, the URLLC network slice controller receives the response message from the producer server in response to sending the create MOI request message. Further, the URLLC network slice controller receives the report from the producer server by the file and/or the stream data, where the report includes the energy efficiency of the URLLC network slice based on the reliability. Further, the URLLC network slice controller optimizes the URLLC network slice for the energy efficiency by utilizing the received report.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### Advantageous Effects of Invention

Aspects of the present disclosure provide efficient communication methods in a wireless communication system.

### BRIEF DESCRIPTION OF DRAWINGS

This disclosure is illustrated in the accompanying drawings, throughout which like reference letters indicate corresponding parts in the various figures.

FIG. 1 illustrates various Network Slice (NS), according to a prior art disclosed herein;

FIG. 2A illustrates a block diagram of a producer server for determining an energy efficiency of an Ultra-Reliable Low Latency Communications (URLLC) network slice based on reliability, according to an embodiment as disclosed herein;

FIG. 2B illustrates a block diagram of a consumer server for determining the energy efficiency of the URLLC network slice based on the reliability, according to an embodiment as disclosed herein;

FIG. 3A illustrates a sequence flow diagram for determining the energy efficiency of the URLLC network slice based on the reliability, according to an embodiment as disclosed herein;

FIG. 3B illustrates a sequence flow diagram for determining the energy efficiency of the URLLC network slice based on the reliability, according to an embodiment as disclosed herein;

FIG. 4 is a flow chart illustrating a scenario for determining the energy efficiency of the URLLC network slice based on the reliability, according to the embodiments as disclosed herein;

FIG. 5 is a flow diagram illustrating a method for determining the energy efficiency of the URLLC network slice based on the reliability, according to an embodiment as disclosed herein;

FIG. 6 is a block diagram illustrating a structure of a UE according to an embodiment of the disclosure;

FIG. 7 is a block diagram illustrating a structure of a base station according to an embodiment of the disclosure; and

FIG. 8 is a block diagram illustrating a structure of a network entity according to an embodiment of the disclosure.

### BEST MODE FOR CARRYING OUT THE INVENTION

Accordingly, the embodiment herein is to provide a method for determining an energy efficiency of an Ultra-Reliable Low Latency Communications (URLLC) network slice based on reliability. The method includes determining, by a producer server (100), a Packet Success Rate (PSR) for one or more network interfaces in at least one of an Uplink (UL) direction and a Down Link (DL) direction for a given time period constraint, and a Mean Time Between Failures (MTBF) in a network. Further, the method includes determining, by the producer server (100), a reliability of the URLLC network slice based on at least one of the PSR and the MTBF. Further, the method includes determining, by the producer server (100), the energy efficiency of the URLLC network slice based on the reliability of the URLLC network slice.

In an embodiment, the method includes determining the PSR for one or more network interfaces in the at least one of the UL direction and the DL direction for the given time period constraint comprises at least one of: determining, by the producer server (100), the PSR over a Uu Interface in at least one of the DL direction for a split gNodeB, the UL direction for a non-split gNB, and the DL direction for the non-split gNB, determining, by the producer server (100), the PSR over a F1-U Interface in at least one of the UL direction and the DL direction for the split gNB, determining, by the producer server (100), the PSR over the Uu interface including gNodeB Centralized Unit (gNB-CU) and the F1-U interface in the UL direction for the split gNB, determining, by the producer server (100), a number of outgoing GPRS Tunnelling Protocol (GTP) data packets on an N3 interface from a User Plane Function (UPF) per Single-Network Slice Selection Assistance Information (S-NSSAI) sub-counter, determining, by the producer server (100), a number of incoming GTP data packets loss on the N3 interface in a gNB per the S-NSSAI sub-counter, determining, by the producer server (100), a number of incoming GTP data packets loss on the N3 interface in the UPF per the S-NSSAI sub-counter, determining, by the producer server (100), a number of GTP data packets on the N3 interface, wherein the number of GTP data packets have been accepted and successfully processed by a GTP-U protocol entity in the UPF per the S-NSSAI sub-counter, determining, by the producer server (100), a number of octets of GTP data packets, wherein the number of octets of GTP data packets are not successfully received at the gNB over the N3 interface after being transmitted by the UPF per the S-NSSAI sub-counter, and determining, by the producer server (100), a number of octets of GTP data packets loss on the N3 interface in the UPF per the S-NSSAI sub-counter.

In an embodiment, the producer server determines the average MTBF of the URLLC network slice/service that indicates a time period wherein the URLLC network slice/service remains available before becoming unavailable as a per S-NSSAI sub-counter.

In an embodiment, the method includes determining, by the producer server (100), the reliability of the URLLC network slice based on at least one of the PSR and the MTBF comprises: determining, by the producer server (100), the at least one of the PSR and the MTBF to determine the reliability of the URLLC network slice based on at least one of a type of service and a type of a slice of the network. Further, the method includes performing, by the producer server (100), at least one of: determining the reliability of the URLLC network slice based on the determined PSR, determining the reliability of the URLLC network slice based on the determined MTBF, and determining the reliability of the URLLC network slice based on the selected PSR and the selected MTBF.

In an embodiment, the method includes determining, by the producer server (100), the energy efficiency of the URLLC network slice based on the reliability comprises: determining, by the producer server (100), a total amount of energy consumption of the URLLC network slice for the given time period constraint and determining, by the producer server (100), the energy efficiency of the URLLC network slice based on the reliability and the total amount of energy consumption.

In an embodiment, the method includes receiving, by the producer server (100), a create Managed Object Instance (MOI) request message from a consumer server (200) to create a MOI for perfMetricJob IOC, wherein the perfMetricJob IOC comprises a Key Performance Indicator (KPI) for energy efficiency of the URLLC network slice based on the reliability of the URLLC network slice. Further, the method includes sending, by the producer server (100), a measurement collection request to a Network Function (NF) server (300) in response to receiving the create MOI request message from the consumer server (200) and Further, the method includes receiving, by the producer server (100), measurement information from the NF server (300) to determine the at least one of the PSR and the MTBF.

In an embodiment, the method includes creating, by the producer server (100), a report based on the determined energy efficiency and further, the method includes sending, by the producer server (100), the report to the consumer server (200) by at least one of a file and a stream of data, wherein the consumer server (200) optimizes at least one URLLC network slice for the energy efficiency by utilizing the received report.

In an embodiment, the method includes sending, by the consumer server (200), a create Manage Object Instance (MOI) request message to the producer server (100) to create the MOI. Further, the method includes receiving, by the consumer server (200), a response message from the producer server (100) in response to sending the create MOI request message. Further, the method includes receiving, by the consumer server (200), a report from the producer server (100) by at least one of a file and a stream data. And further, the method includes optimizing, by the consumer server (200), at least one URLLC network slice for the energy efficiency by utilizing the received report.

Accordingly, the embodiment herein is to provide a method for optimizing at least one of an Ultra-Reliable Low Latency Communications (URLLC) network slice for an energy efficiency. The method includes sending, by a consumer server (200), a create Manage Object Instance (MOI) request message to a producer server (100) to create a MOI. further, the method includes receiving, by the consumer server (200), a response message from the producer server (100) in response to sending the create MOI request message. further, the method includes receiving, by the consumer server (200), a report from the producer server (100) by at least one of a file and a stream data, wherein the report comprises an energy efficiency of the URLLC network slice based on a reliability. And further, the method includes optimizing, by the consumer server (200), the at least one URLLC network slice for the energy efficiency by utilizing the received report.

Accordingly, the embodiment herein is to provide a producer server (100) for determining an energy efficiency of an Ultra-Reliable Low Latency Communications (URLLC) network slice based on reliability. The producer server (100) comprises a memory (1100), a processor (120), and an URLLC network slice controller (140), operably connected to the memory (110). and the processor (120), configured to determine a Packet Success Rate (PSR) for one or more network interfaces in at least one of an Uplink (UL) direction and a Down Link (DL) direction for a given time period constraint, and a Mean Time Between Failures (MTBF) in a network. Further, the processor (120) configured to determine a reliability of the URLLC network slice based on at least one of the PSR and the MTBF. And further, the processor (120) configured to determine the energy efficiency of the URLLC network slice based on the reliability of the URLLC network slice.

In an embodiment, the producer server (100) as claimed in claim 10, wherein determine the PSR for one or more network interfaces in the at least one of the UL direction and the DL direction for the given time period constraint comprises at least one of: determine the PSR over a Uu Interface in at least one of the DL direction for a split gNodeB, the UL direction for a non-split gNB, and the DL direction for the non-split gNB, determine the PSR over a F1-U Interface in at least one of the UL direction and the DL direction for the split gNB, determine the PSR over the Uu interface including gNodeB Centralized Unit (gNB-CU) and the F1-U interface in the UL direction for the split gNB, determine a number of outgoing GPRS Tunnelling Protocol (GTP) data packets on an N3 interface from a User Plane Function (UPF) per Single-Network Slice Selection Assistance Information (S-NSSAI) sub-counter, determine a number of incoming GTP data packets loss on the N3 interface in the gNB per the S-NSSAI sub-counter, determine a number of incoming GTP data packets loss on the N3 interface in the UPF per the S-NSSAI sub-counter, determine a number of GTP data packets on the N3 interface, wherein the number of GTP data packets have been accepted and successfully processed by the GTP-U protocol entity in the UPF per the S-NSSAI sub-counter, determine a number of octets of GTP data packets, wherein the number of octets of GTP data packets are not successfully received at the gNB over the N3 interface after being transmitted by the UPF per the S-NSSAI sub-counter, and determine a number of octets of GTP data packets loss on the N3 interface in the UPF per the S-NSSAI sub-counter.

In an embodiment, the producer server (100) determines the average MTBF of the URLLC network slice/service that indicates a time period wherein the URLLC network slice/service remains available before becoming unavailable as a per S-NSSAI sub-counter.

In an embodiment, the producer server (100) determines the reliability of the URLLC network slice based on at least one of the PSR. the MTBF comprises: determine the at least one of the PSR and the MTBF to determine the reliability of the URLLC network slice based on at least one of a type of service and a type of a slice of the network, perform at least one of: determining the reliability of the URLLC network slice based on the determined PSR, and determining the reliability of the URLLC network slice based on the determined MTBF, and determining the reliability of the URLLC network slice based on the selected PSR and the selected MTBF.

In an embodiment, the producer server determines the energy efficiency of the URLLC network slice based on the reliability. the producer comprises determine a total amount of energy consumption of the URLLC network slice for the given time period constraint and determine the energy efficiency of the URLLC network slice based on the reliability and the total amount of energy consumption.

In an embodiment, the URLLC network slice controller (140) is configured to receive a create Manage Object Instance (MOI) request message from a consumer server (200) to create a MOI for perfMetricJob IOC, wherein the perfMetricJob IOC comprises a Key Performance Indicator (KPI) for energy efficiency of the URLLC network slice based on the reliability of the URLLC network slice. the URLLC network slice controller (140) is configured to send a measurement collection request to a Network Function (NF) server (300) in response to receiving the create MOI request message from the consumer server (200). the URLLC network slice controller (140) is configured to receive measurement information from the NF server (300) to determine the at least one of the PSR and the MTBF.

In an embodiment, the URLLC network slice controller (140) is configured to create a report based on the determined energy efficiency of the URLLC network slice. the URLLC network slice controller (140) is configured to send the report to the consumer server (200) by at least one of a file and a stream of data, wherein the consumer server (200) optimizes at least one URLLC network slice for the energy efficiency by utilizing the received report.

Accordingly, the embodiment herein is to provide a consumer server (200) optimizing at least one of an Ultra-Reliable Low Latency Communications (URLLC) network slice for an energy efficiency. the consumer server (200) comprising a memory (210), a processor (220), and an URLLC network slice controller (240), operably connected to the memory (210). The processor (220) configured to send a create Manage Object Instance (MOI) request message to a producer server (100) to create a MOI. Further the processor (220) configured to receive a response message from the producer server (100) in response to sending the create MOI request message. Further the processor (220) configured to receive a report from the producer server (100) by at least one of a file and a stream data, wherein the report comprises an energy efficiency of the URLLC network slice based on its reliability. Further the processor (220) configured to optimize the at least one URLLC network slice for the energy efficiency by utilizing the received report.

### MODE FOR INVENTION

5th Generation (5G) network is anticipated to be able to provide optimum support for several services (e.g. voice service), varied traffic loads, and different end-user groups, in comparison to previous 3rd Generation Partnership Project (3GPP) networks that aimed to deliver a “one size fits all” system. A multifaceted 5G network is expected to support many simultaneous combinations of multiple combinations of reliability, latency, throughput, positioning, and availability for access network and/or core network. Since the multifaceted 5G network consumes more energy, an Energy Efficiency (EE) of the multifaceted 5G network becomes more difficult to manage. For example, in vertical applications with extremely high availability, dependability, and end-to-end latencies that are particularly difficult to manage. Therefore, evaluating the EE is crucial for network operators who want to keep their Operating Expense (OPEX) under control, especially their network (e.g., 5G network) energy OPEX. The network operators must be aware of the EE of the network before taking any action to reduce network energy OPEX.

The EE can be addressed from a variety of perspectives, such as the EE for a specific performance or at a specific level, such as at a level of a sub network (for example, Radio Access Network (RAN)/Core) or a Network Slice (NS). When evaluated over the same period, the EE is a ratio between performance indicators and energy usage. For example, in a Network Slice as a Service (NSaaS) model, a Network Slice Customer (NSC) may ask to its Network Slice Provider (NSP) for the NS with certain characteristics, among which could be expected EE of the NS. Therefore, EE Key Performance Indicator (KPIs) needs to be defined so that such EE KPIs can be measured and delivered by the network (e.g., NS providers). For example, the EE of enhanced Mobile Broadband (eMBB) network slice and/or Ultra-Reliable Low-Latency Communication (URLLC) network slice and/or Massive IoT (MIoT) network slice.

Furthermore, existing system/current 3GPP standards/Communication Service Provider (CSP)/Network Operations Portal (NOP) determines the EE KPI of the URLLC network slice based on NS's latency performance only and not reliability which is a shortcoming of the existing system. For example, remote driving as in Vehicle-to-everything (V2X) applications where reliability requirements are very stringent to be 99.999%. Thus, it is desired to address the above-mentioned disadvantages or other shortcomings or at least provide a useful alternative for determining the EE of the URLLC network slice based on reliability.

The principal object of the embodiments herein is to provide a method and apparatus to determine an energy efficiency of an Ultra-Reliable Low Latency Communications (URLLC) network slice based on reliability by determining a Packet Success Rate (PSR) for one or more network interfaces (e.g. Uu interface) in at least one of an Uplink (UL) direction and a Down Link (DL) direction for a given time period constraint, and/or a Mean Time Between Failures (MTBF). As a result, a network operator of the URLLC network slice optimizes a network based on the energy efficiency. So, the network operator provides better service to a consumer/user for various applications (e.g. cyber-physical control application, Vehicle-to-everything (V2X) application, etc.)

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

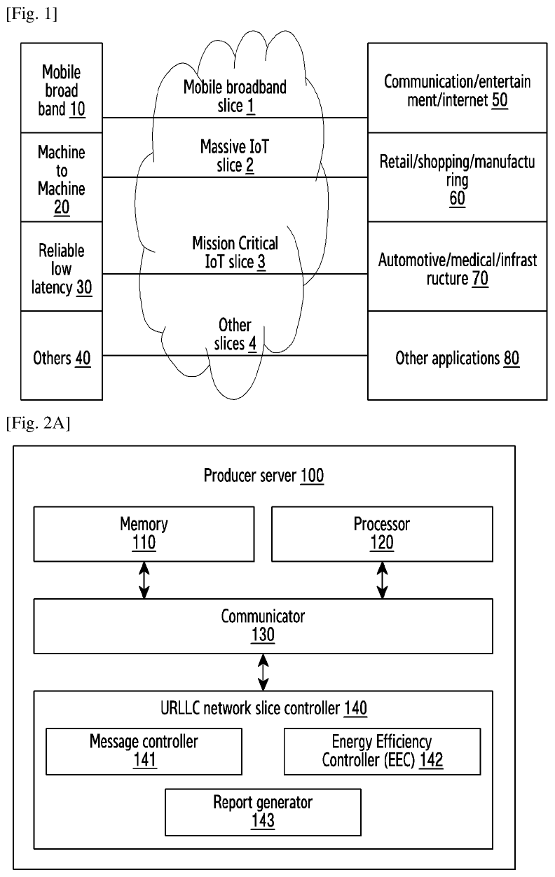

FIG. 1 through FIG. 5, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

FIG. 1 illustrates various Network Slice (NS). An interface between devices and antennas (for example, the air interface) will have numerous different specialized/tailored behaviors to satisfy needs of different sorts of machines and devices. These are referred to as slice types (e.g. mobile broadband slice (1), massive IoT slice (2), mission-critical IoT slice (3), other slices (4), etc.) using cloud and packet-based statistical multiplexing techniques are employed to allow the slices to use each other's resources when they are free. In this manner, N-network slices can be imple-mented with far less than N×the number of resources.

The mobile broadband slice (1) is specifically targeted for ultra-low latency and high reliability (like self-driving vehicles) (URLLC) for services like mobile broadband (10) for communication and/or entertainment and/or internet (50). The massive IoT slice (2) is specifically targeted for the devices that don't have large batteries (like sensors) and need efficiency for services like Machine to Machine (20) for retail and/or shopping and/or manufacturing (60). The mission-critical IoT slice (3) is targeted at ultra-high speed (eMBB) as required for 4K resolution or immersive 3-Dimensional (3D) video for service like reliable low latency (30) for automotive and/or medical and/or infrastructure (70). Initial standards work calls for only three slice types (i.e. 1/2/3), architectures are flexible for future slice types (4) for other services (40) for other applications (80).

Current 3GPP standards have a drawback in that they only evaluate a URLLC Network Slice's (NS) Energy Efficiency (EE) KPI based on its latency performance. When evaluating the EE KPI of the URLLC NS, latency and reliability should be taken into account because they are both equally significant. Consider a scenario where Communication Service Provider (CSP)/Network Operations Portal (NOP) wants to assess the EE KPI with respect to the “reliability” of the URLLC NS which is being used for communication services requiring very high reliability, such as V2X services where in case of Remote Driving, information exchange between a User Equipment (UE) supporting V2X application and a V2X application server must have a reliability of 99.999% as specified in 3GPP TS 22.186. Another example includes a cyber-physical control application having periodic deterministic communication. In a case of Robotic aided diagnosis, Mean Time Between Failures (MTBF) of a communication service needs to be between 1 month to 1 year as specified in 3GPP TS 22.104. The CSP/NOP providing such crucial services may want to check the EE KPI of the URLLC NS with respect to its reliability in addition to latency so that the more comprehensive and efficient EE KPI of the URLLC NS can be determined.

Accordingly, the embodiment herein is to provide a method for determining an energy efficiency of an Ultra-Reliable Low Latency Communications (URLLC) network slice based on reliability. The method includes determining, by a producer server, a Packet Success Rate (PSR) for one or more network interfaces in an Uplink (UL) direction(s) and/or a Down Link (DL) direction(s) for a given time period constraint, and/or a Mean Time Between Failures (MTBF). Further, the method includes determining, by the producer server, a reliability of the URLLC network slice based on the PSR and/or the MTBF. Further, the method includes determining, by the producer server, the energy efficiency of the URLLC network slice based on the reliability of the URLLC network slice.

Accordingly, the embodiment herein is to provide a method for optimizing one or more of the URLLC network slice for the energy efficiency. The method includes sending, by the consumer server, the create MOI request message to the producer server, where the message indicates the request to create the MOI. Further, the method includes receiving, by the consumer server, the response message from the producer server in response to sending the create MOI request message. Further, the method includes receiving, by the consumer server, the report from the producer server by the file and/or the stream data, where the report includes the energy efficiency of the URLLC network slice based on the reliability. Further, the method includes optimizing, by the consumer server, the URLLC network slice for the energy efficiency by utilizing the received report.

Accordingly, the embodiments herein provide the producer server for determining the energy efficiency of the URLLC network slice based on the reliability. The producer server includes a URLLC network slice controller coupled with a processor and a memory. The URLLC network slice controller determines the PSR for one or more network interfaces in the UL direction(s) and/or the DL direction(s) for the given time period constraint, and/or the MTBF. Further, the URLLC network slice controller determines the reliability of the URLLC network slice based on the PSR and/or the MTBF. Further, the URLLC network slice controller determines the energy efficiency of the URLLC network slice based on the reliability of the URLLC network slice.

Accordingly, the embodiments herein provide the consumer server for optimizing the URLLC network slice based on the energy efficiency. The producer server includes a URLLC network slice controller coupled with a processor and a memory. The URLLC network slice controller sends the create MOI request message to the producer server to create the MOI. Further, the URLLC network slice controller receives the response message from the producer server in response to sending the create MOI request message. Further, the URLLC network slice controller receives the report from the producer server by the file and/or the stream data, where the report includes the energy efficiency of the URLLC network slice based on the reliability. Further, the URLLC network slice controller optimizes the URLLC network slice for the energy efficiency by utilizing the received report.

Unlike existing methods and systems, the proposed method and system determine the energy efficiency of the URLLC network slice based on the reliability by determining the PSR for one or more network interfaces (e.g. Uu interface) in the UL direction(s) and/or the DL direction(s) for the given time period constraint and/or the MTBF. As a result, a network operator of the URLLC network slice optimizes a network based on the energy efficiency. So, the network operator provides better service to a consumer/user for various applications (e.g. cyber-physical control application, Vehicle-to-everything (V2X) application, etc.)

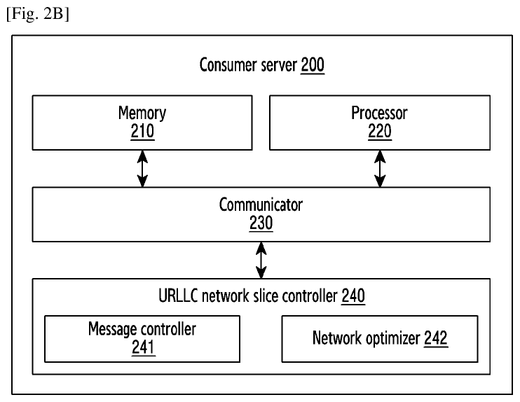

Referring now to the drawings, and more particularly to FIG. 2A through FIG. 5, where similar reference characters denote corresponding features consistently throughout the figures, there are shown preferred embodiments.

FIG. 2A illustrates a block diagram of a producer server (100) (e.g., Operations Support System (OSS) and Business Support System (BSS), etc.) for determining an energy efficiency of an Ultra-Reliable Low Latency Communications (URLLC) network slice based on reliability, according to an embodiment as disclosed herein;

In an embodiment, the producer server (100) includes a memory (110), a processor (120), a communicator (130), and a URLLC network slice controller (140).

In an embodiment, the memory (110) stores a Packet Success Rate (PSR) for one or more network interfaces in an Uplink (UL) direction(s) and/or a Down Link (DL) direction(s) for a given time period constraint, a Mean Time Between Failures (MTBF), a reliability, an energy efficiency, and a report. The memory (110) stores instructions to be executed by the processor (120). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit or it can be an external storage unit of the producer server (100), a cloud storage, or any other type of external storage.

The processor (120) communicates with the memory (110), the communicator (130), and the URLLC network slice controller (140). The processor (120) is configured to execute instructions stored in the memory (110) and to perform various processes. The processor (120) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (130) is configured for communicating internally between internal hardware components and with external devices (e.g. eNodeB, gNodeB, server, etc.) via one or more networks (e.g. Radio technology). The communicator (130) includes an electronic circuit specific to a standard that enables wired or wireless communication.

The URLLC network slice controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. In addition, the operation of the URLLC network slice controller(140) may be performed by the processor (120).

In an embodiment, the URLLC network slice controller (140) includes a message controller (141), an Energy Efficiency Controller (EEC) (142), and a report generator (143).

The message controller (141) receives a create Manage Object Instance (MOI) request message from a consumer server (200) to create a MOI for perfMetricJob IOC, where the perfMetricJob IOC includes a Key Performance Indicator (KPI) for energy efficiency of the URLLC network slice based on the reliability of the URLLC network slice. The message controller (141) sends a measurement collection request to a Network Function (NF) server (300) in response to receiving the create MOI request message from the consumer server (200). The message controller (141) receives measurement information from the NF server (300) to determine the PSR and/or the MTBF (mean time period for which the service/slice remains available before it becomes unavailable, as a per S-NSSAI sub-counter).

The EEC (142) determines the PSR for one or more network interfaces in the UL direction(s) and/or the DL direction(s) for the given time period constraint, and/or the MTBF. The EEC (142) determines the PSR over a Uu Interface in the DL direction for a split gNodeB and/or the UL direction for a non-split gNB, and/or the DL direction for the non-split gNB. The EEC (142) determines the PSR over a F1-U Interface in the UL direction and/or the DL direction for the split gNB. The EEC (142) determines the PSR over the Uu interface including a gNodeB Centralized Unit (gNB-CU), and the F1-U interface in the UL direction for the split gNB; determining, by the producer server, a number of outgoing GPRS Tunnelling Protocol (GTP) data packets on an N3 interface from a User Plane Function (UPF) per Single-Network Slice Selection Assistance Information (S-NSSAI) sub-counter. The EEC (142) determines a number of incoming GTP data packets loss on an N3 interface in the gNB per the S-NSSAI sub-counter. The EEC (142) determines a number of incoming GTP data packets loss on the N3 interface in the UPF per the S-NSSAI sub-counter. The EEC (142) determines a number of GTP data packets on the N3 interface which have been accepted and successfully processed by the GTP-U protocol entity in the UPF per the S-NSSAI sub-counter. The EEC (142) determines a number of octets of GTP data packets which are not successfully received at the gNB over the N3 interface after being transmitted by the UPF per the S-NSSAI sub-counter. The EEC (142) determines a number of octets of GTP data packets loss on the N3 interface in the UPF per the S-NSSAI sub-counter.

The EEC (142) determines the reliability of the URLLC network slice based on the PSR and/or the MTBF. The EEC (142) selects the PSR and/or the MTBF to determine the reliability of the URLLC network slice based on a type of service and/or a type of a slice of the network. The EEC (142) determines the reliability of the URLLC network slice based on the determined PSR. The EEC (142) determines the reliability of the URLLC network slice based on the determined MTBF. The EEC (142) determines the reliability of the URLLC network slice based on the determined PSR and the determined MTBF.

The EEC (142) determines a total amount of energy consumption of the URLLC network slice for the given time period constraint. The EEC (142) determines the energy efficiency of the URLLC network slice based on the reliability and the total amount of energy consumption.

The report generator (143) creates the report based on the determined energy efficiency of the URLLC network slice. The report generator (143) sends the report to the consumer server (200) by a file and/or a stream of data, where the consumer server (200) optimizes a URLLC network slice (s) for the energy efficiency by utilizing the received report.

Although the FIG. 2A shows various hardware components of the producer server (100) but it is to be understood that other embodiments are not limited thereon. In other embodiments, the producer server (100) may include less or more number of components. Further, the labels or names of the components are used only for illustrative purpose and does not limit the scope of the disclosure. One or more components can be combined to perform the same or substantially similar function to determine the energy efficiency of the URLLC network slice based on the reliability.

FIG. 2B illustrates a block diagram of the consumer server (200) for determining the energy efficiency of the URLLC network slice based on the reliability, according to an embodiment as disclosed herein.

In an embodiment, the consumer server (200) includes a memory (210), a processor (220), a communicator (230), and a URLLC network slice controller (240).

In an embodiment, the memory (210) stores the report. The memory (210) stores instructions to be executed by the processor (220). The memory (210) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (210) may, in some examples, be considered a non-transitory storage medium. The term “non-transitory” may indicate that the storage medium is not embodied in a carrier wave or a propagated signal. However, the term “non-transitory” should not be interpreted that the memory (210) is non-movable. In some examples, the memory (210) can be configured to store larger amounts of information than the memory. In certain examples, a non-transitory storage medium may store data that can, over time, change (e.g., in Random Access Memory (RAM) or cache). The memory (210) can be an internal storage unit or it can be an external storage unit of the consumer server (200), a cloud storage, or any other type of external storage.

The processor (220) communicates with the memory (210), the communicator (230), and the URLLC network slice controller (240). The processor (220) is configured to execute instructions stored in the memory (210) and to perform various processes. The processor (220) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (230) is configured for communicating internally between internal hardware components and with external devices (e.g. eNodeB, gNodeB, server, etc.) via one or more networks (e.g. Radio technology). The communicator (230) includes an electronic circuit specific to a standard that enables wired or wireless communication.

The URLLC network slice controller (240) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. In addition, the operation of the URLLC network slice controller(240) may be performed by the processor (220).

In an embodiment, the URLLC network slice controller (240) includes a message controller (241) and a network optimizer (242). The message controller (241) sends the create MOI request message to the producer server (100) to create the MOI. The message controller (241) receives the response message from the producer server (100) in response to sending the create MOI request message. The network optimizer (242) receives the report from the producer server (100) by the file and/or the stream data, where the report includes the energy efficiency of the URLLC network slice based on the reliability. The network optimizer (242) optimizes the URLLC network slice (s) for the energy efficiency by utilizing the received report.

Although the FIG. 2B shows various hardware components of the consumer server (200) but it is to be understood that other embodiments are not limited thereon. In other embodiments, the consumer server (200) may include less or more number of components. Further, the labels or names of the components are used only for illustrative purpose and does not limit the scope of the disclosure. One or more components can be combined to perform the same or substantially similar function to optimize the URLLC service(s) by utilizing the received report.

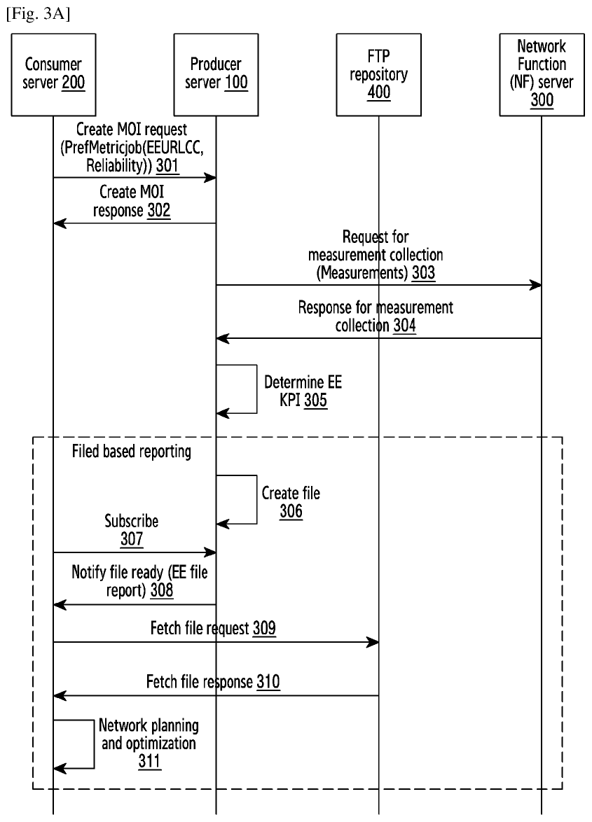

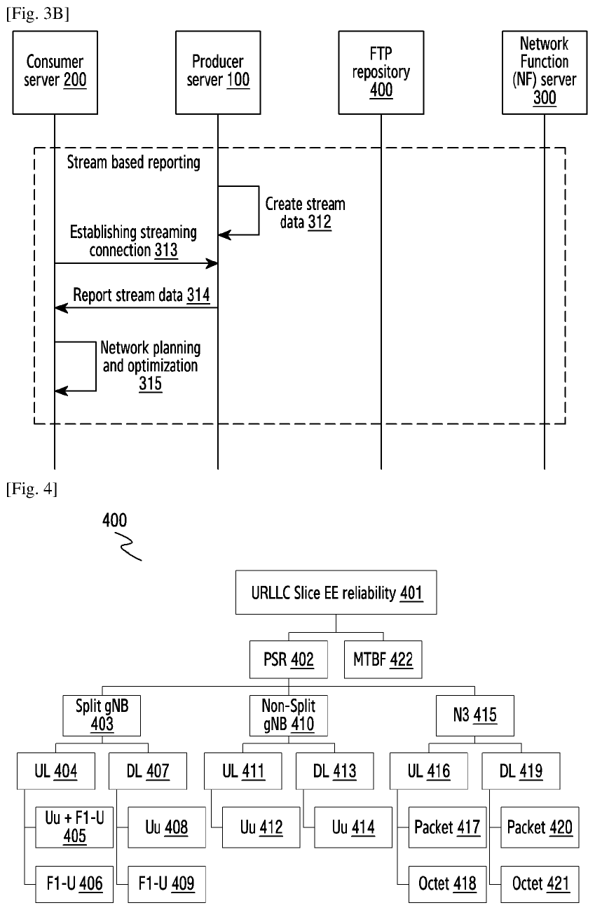

FIG. 3A illustrates a sequence flow diagram for determining the energy efficiency of the URLLC network slice based on the reliability, according to an embodiment as disclosed herein. A role of the consumer server (200) is played by a Generic Provisioning MnS consumer and the producer server (100) is played by a Generic Provisioning MnS producer respectively.

At step 301, the consumer server (200) sends the create MOI request message to the producer server (100) to create the MOI as defined in 3GPP TS 28.532. The create MOI request message includes EEURLLC, Reliability as part of performance Metrics attributes of performance Metrics Job IOC. At step 302, the consumer server (200) receives the response message from the producer server (100) in response to sending the create MOI request message. At step 303, the producer server (100) sends the measurement collection request to a respective Network Function (NF) server (300) to produce a data/measurement in response to receiving the create MOI request message from the consumer server (200). The measurement to be collected includes the existing measurement and is defined by the proposed method, as shown in Table-1, same explained in FIG. 4.

TABLE 1
Measurement defined by the proposed method

DRB.PacketSuccessRateUlUu.SNSSAI
GTP.InDataPktPacketLossN3UPF.SNSSAI
GTP.InDataPktN3UPF.SNSSAI
GTP.OutDataPktN3UPF.SNSSAI
GTP.InDataPktPacketLossN3gNB.SNSSAI
GTP.InDataOctetLossN3UPF.SNSSAI
GTP.InDataOctetLossN3gNB.SNSSAI
DRB.PacketSuccessRateUl.SNSSAI
DRB.F1UPacketSuccessRateUl.SNSSAI
DRB.F1UPacketSuccessRateDl.SNSSAI
S(T₁,drbid).SNSSAI
MTBF.SNSSAI

At step 304, the producer server (100) receives the measurements from the NF server (300). At step 305, the producer server (100) determines the energy efficiency (i.e. EE KPI).

Alternative reporting method-1: at step 306, where the producer server (100) generates/creates the report based on the determined energy efficiency of the URLLC network slice. At step 307, the consumer server (200) subscribes to receive fileReadyNotification as defined in 3GPP TS 28.532. At step 308, the producer server (100) sends the fileReadyNotification to the consumer server (200) once the file is ready. At step 309, the consumer server (200) sends a fetch file request to a File Transfer Protocol (FTP) repository (400) in response to receiving the fileReadyNotification. At step 310, the consumer server (200) receives a fetch file response in response to sending the fetch file request from FTP repository (400). At step 311, the consumer server (200) may take network optimization and planning decisions based on the received report.

FIG. 3B illustrates a sequence flow diagram for determining the energy efficiency of the URLLC network slice based on the reliability, according to an embodiment as disclosed herein. Especially, FIG. 3B illustrate Alternative reporting method-2 following FIG. 3A. A role of the consumer server (200) is played by a Generic Provisioning MnS consumer and the producer server (100) is played by a Generic Provisioning MnS producer respectively.

At step 312, where the producer server (100) generates/creates the stream of data based on the determined energy efficiency of the URLLC network slice. At step 313, the consumer server (200) sends an establishStreamConenction as defined in 3GPP TS 28.532. At step 314, the consumer server (200) receives a reportStreamData in order to set up the stream of data flow from the producer server (100). At step 315, the consumer server (200) may take network optimization and planning decisions based on the received report.

FIG. 4 is a flow chart (400) illustrating a scenario for determining the energy efficiency of the URLLC network slice based on the reliability, according to the embodiments as disclosed herein.

The proposed method defines methodologies to assess the EE KPI considering the reliability of the URLLC network slice. The proposed method considers the reliability of the URLLC network slice in two ways as generally practiced by the CSPs/NOPs in their network i.e. based on “percentage of successfully delivered packets within a time constraint” as defined in 3GPP TS 22.261 and 3GPP TS 22.289 and based on the MTBF as defined in 3GPP TS 22.104 and 3GPP TS 22.289, which enables the CSPs/NOPs to have a robust and complete view of its URLLC slice's EE KPI and also provides them with a choice of selecting either or both of these two methods depending on the nature of service/use case fulfilled by the network slice.

The proposed method also defines measurements that are required to successfully execute the proposed methods. Such as the PSR over the Uu interface in the UL direction(s) for the non-split gNB, the PSR including success in the air interface, within the gNB-CU, and over the F1-U interface in the UL direction(s) for the split gNB, the PSR over the F1-U interface in the UL direction(s) for the split gNB, the PSR over the F1-U interface in the DL direction(s) for the split gNB, the PSR over the Uu interface in the DL direction(s) for the split/non-split gNB, the number of incoming and outgoing the GTP data packets on the N3 interface as per the S-NSSAI sub-counter, the number of lost GTP data Packets in the UL direction(s) and the DL direction(s) over the N3 interface as per the S-NSSAI sub-counter, the number of lost octets of GTP data packets in the UL direction(s) and the DL direction(s) over the N3 interface as per the S-NSSAI sub-counter, and the MTBF in the network slice/service.

The proposed method involves dividing the reliability performance of the URLLC network slice (either based on percentage of successfully delivered packets within the time constraint or based on the MTBF) by the total amount of energy consumption of the URLLC network slice at the same given time period constraint.

At 401, the EE KPI of the URLLC network slice is based on the reliability performance, which is represented as EEURLLC, Reliability. Since the generic EE KPI formula of the network slice is a ratio of the performance of the network slice (e.g., URLLC network slice) to the energy consumption of the network slice hence EE_{URLLC,Reliability} is given by the below equation,

$$Equation ( 1 )$$

$${EE}_{URLLC , Reliability} = \frac{{P}_{NS}}{{EC}_{NS}} = \frac{{P}_{URLLC , Reliability}}{{EC}_{NS}} . \qquad ( 1 )$$

Where PNS is the performance of the network slice. For the URLLC network slice which can be both latency and reliability. Since the proposed method is to establish the EE KPI with respect to the reliability, thus here, the performance of the network slice is in terms of the reliability and hence the PNS is denoted as the P_{URLLC,Reliability}, which is calculated for the desired given time period constraint (T1) and ECNS is the energy consumption of the whole network slice as specified in 3GPP TS 28.554 and 3GPP TR 28.813 and is determined for the same desired given time period constraint T1. In principle it is a summation of energy consumptions of all NFs constituting the network slice.

The reliability performance of the URLLC network slice i.e. P_{URLLC,Reliability} can be determined based on the PSR and/or the MTBF, which are derived via method-1 (i.e. PSR) and method-2 (i.e. MTBF) respectively as explained below, determined by the URLLC network slice controller (140).

Method-1: at 402, the reliability performance is based on the PSR percentage, in a context of network layer packet transmissions, the reliability performance is related to the percentage value of an amount of sent network layer packets successfully delivered to a given system entity within a time constraint divided by a total number of sent network layer packets. So, in this case, P_{URLLC,Reliability} is denoted by P_{URLLC,Reliability}, PSR is given by the below equation,

$$Equation ( 2 )$$

$${P}_{URLLC , REliability , PSR} = PSR \% \times X . \qquad ( 2 )$$

Where the PSR % is the packet success rate percentage and is determined over various interfaces and directions (UL/DL) (i.e. UL direction(s) and DL direction(s)). The X is an internal measurement representing the total number of packets sent over any interface in the URLLC network slice, within the considered time frame T1. If the P_{URLLC,Reliability}, PSR is divided by energy consumption of the network slice (ECNS) which is measured for the same considered given time period constraint T1 then determines the EE KPI i.e. the EE_{URLLC,Reliability}, which essentially informs that “With an evaluated reliability (PSR %), how many packets or bits can be successfully sent per joule of energy over an interface in the URLLC network slice in a given time frame”. So in this case, the EE KPI is given by the below equation,

$$Equation ( 3 )$$

$${EE}_{URLLC , Reliability} = \frac{{P}_{URLLC , Reliability , PSR}}{{EC}_{NS}} . \qquad ( 3 )$$

The P_{URLLC,Reliability}, PSR should be considered the same for the DL direction(s) and/or the UL direction(s) unless specified explicitly separate for any use case. With method-1, the EE_{URLLC,Reliability} of the URLLC network slice has the unit of packets or bits per joule. To convert packets into bits, in the case of the GTP data PDUs based measurements, the producer server (100) obtains a length in the number of octets for each packet from its GTP-U header and multiplies it by 8. In the case of Radio link control (RLC) Service Data Units (SDUs) and PDCP SDUs-based measurements, their size in octets has to be measured at corresponding interfaces and then multiply by 8. The EE_{URLLC,Reliability} can be further determined as per interface type and as per the DL direction(s) and/or the UL direction(s). Throughout the URLLC network slice, the same or different PSR % might exists on different interfaces. If it is the same the PSR % (thus reliability) of the URLLC network slice can be determined at any one segment of the network i.e. between a User Equipment (UE) and the gNB or between the gNB and a UPF. In case, if it is not the same the implementations may choose to determine the PSR % of the URLLC network slice at any interface deemed appropriate for the network operator. The following list shows the possible options and related equations.

The reliability between the UE and the gNB can be determined for both the split gNB (403) and the non-split gNB (410) in both the DL direction(s) (407,413) and/or the UL direction(s) (404,411) for the interfaces (e.g., Uu, F1-U, etc.)

The Reliability for split gNB in uplink direction (404) over Uu and F1-U interface(s) (405): P_{URLLC,Reliability}, PSR as defined above is obtained for the Uu and the F1-U interface in the UL direction(s) by using corresponding PSR % as given by the below equation,

$$Equation ( 4 )$$

$$PSR \% = {PSR}_{UL , Split} = ( DRB . PacketSuccessRateUl . SNSSAI ) \times 100. \qquad ( 4 )$$

Where, the P_{SRUL,Split} is the PSR % in the UL direction(s) between the UE and a gNB-CU-UP in the split gNB and the DRB.PacketSuccessRateUl.SNSSAI is the measurement that provides a fraction of PDCP SDU packets that are successfully received at the gNB-CU-UP. It is a measure of the UL packet delivery success including any packet success in the air interface, in the gNB-CU, and on the F1-U interface. Only user-plane traffic (DTCH) and only PDCP SDUs that have entered PDCP (and given a PDCP sequence number) are considered. The measurement is optionally split into sub counters per Quality of Service (QoS) level (mapped 5QI or QCI in NR option 3), and sub counters per supported S-NSSAI. The measurement is obtained as a number of successfully received UL PDCP sequence numbers, representing packets that are successfully delivered to higher layers, of a data radio bearer, divided by a total number of UL PDCP sequence numbers of a bearer, starting from the sequence number of the first packet delivered by a UE PDCP to the gNB-CU-UP until the sequence number of the last packet. Separate counters are optionally maintained for the mapped 5QI (or QCI for NR option 3) and per supported S-NSSAI. Each measurement is an integer value representing the success rate. The number of measurements is equal to one. If the optional QoS and S-NSSAI level measurements are performed, the measurements are equal to the number of the mapped 5QIs and the number of supported S-NSSAIs.

The reliability for the split gNB in the UL direction(s) over only the FlU interface (406): P_{URLLC,Reliability}, PSR as defined above is obtained for only FTU interface in UL direction(s) by using corresponding PSR % as given by the below equation,

$$Equation ( 5 )$$

$$PSR \% = {PSR}_{UL , F 1 U} = ( DRB . F 1 UPacketSuccessRateUl . SNSSAI ) \times 100. \qquad ( 5 )$$

Where, PSR_{UL,F1U} is the PSR % in the UL direction(s) for the FlU interface in the split gNB and the DRB.F1UPacketSuccessRateUl.SNSSAI is the measurement that provides the fraction of PDCP SDU packets that are successfully received at the gNB-CU-UP. It is a measure of the UL packet delivery success on the F1-U interface. The measurement is optionally split into sub counters per the QoS level (the mapped 5QI or QCI in NR option 3) and sub counters per supported S-NSSAI. The measurement is obtained as the Number of successfully received UL GTP sequence numbers (3GPP TS 29.281), representing packets that are successfully delivered to higher layers, of a data radio bearer, divided by the total number of UL GTP sequence numbers of a bearer, starting from the GTP sequence number of the first packet delivered by a gNB-Distributed Unit (DU) to the gNB-CU-UP until the GTP sequence number of the last packet. Separate counters are optionally maintained for the mapped 5QI (or QCI for option 3) and per supported S-NSSAI. Each measurement is an integer value representing the success rate. The number of measurements is equal to one. If the optional QoS and S-NSSAI level measurements are performed, the measurements are equal to the number of the mapped 5QIs and the number of supported S-NSSAIs.

The reliability calculation for the split gNB in the DL direction(s) (407) over the Uu interface (408): the P_{URLLC,Reliability}, PSR is obtained for the Uu interface by using corresponding PSR % as given by the below equation,

$$Equation ( 6 )$$

$$PSR \% = {PSR}_{DL , Uu , split} = S ( T 1 , drbid ) . SNSSAI \times 100. \qquad ( 6 )$$

$$and ,$$

$$Equation ( 7 )$$

$$S ( T 1 , drbid ) . SNSSAI = ⌊ \frac{N ( T 1. drbid )}{N ( T 1. drbid ) + Dloss ( T 1 . d r b i d )} ⌋ . \qquad ( 7 )$$

Where, the PSR_{DL,Uu,Split} is PSR % in the DL direction(s) for the Uu interface in the split gNB.S(T1, drbid).SNSSAI is Uu Packet Success Rate in the DL per DRB per SNSSAI per UE. One packet corresponds to one RLC SDU. The measurement is done separately per DRB and must be reported by UE per S-NSSAI, drbid is the identity of the measured DRB, Dloss (T1, drbid) is the number of DL packets of a data radio bearer with DRB Identity=drbid, for which at least a part has been transmitted over the air but not positively acknowledged, and which was decided during given time period constraint T1 that no more transmission attempts will be done. N (T1, drbid) is the number of DL packets, of a data radio bearer with DRB Identity=drbid, which has been transmitted over the air and positively acknowledged during given time period constraint T1.

The reliability for the split gNB in the DL direction(s) (407) over the F1-U interface (409): P_{URLLC,Reliability,PSR} is obtained for the F1-U interface by using corresponding PSR % as given by the below equation,

$$Equation ( 8 )$$

$$PSR \% = {PSR}_{DL , F 1 U} = ( DRB . F 1 UPacketSuccessRateDl . SNSSAI ) \times 100. \qquad ( 8 )$$

Where, PSR_{DL,F1U} is the PSR % in the DL direction(s) for the F1-U interface in the split gNB and the DRB.F1UPacketSuccessRateDl.SNSSAI is the measurement that provides the fraction of PDCP SDU packets that are successfully received at the gNB-DU. It is a measure of the DL packet delivery success on the F1-U interface. The measurement is optionally split into sub counters per QoS level (the mapped 5QI or QCI in NR option 3), and sub counters per supported S-NSSAI. The measurement is obtained as number of successfully received DL GTP sequence numbers (3GPP TS 29.281), representing packets that are successfully delivered to lower layers, of a data radio bearer, divided by a Total number of UL GTP sequence numbers of a bearer, starting from the sequence number of the first packet delivered by the gNB-CU-UP to the gNB-DU until the GTP sequence number of the last packet. Separate counters are optionally maintained for the mapped 5QI (or QCI for NR option 3) and per supported S-NSSAI. Each measurement is an integer value representing the success rate. The number of measurements is equal to one. If the optional QoS and S-NSSAI level measurements are performed, the measurements are equal to the number of the mapped 5QIs and the number of supported S-NSSAIs.

The reliability for the non-split gNB (410) in the UL direction(s) (411) over the Uu interface (412): P_{URLLC,Reliability}, PSR is obtained for the Uu interface by using PSR % as given by the below equation,

$$Equation ( 9 )$$

$$PSR \% = {PSR}_{UL , Uu . non - split} = ( DRB . PacketSuccessRateUlUu . SNSSAI ) \times 100. \qquad ( 9 )$$

Where, PSR_{UL,Uu,non-split} is the PSR % in the UL direction(s) (411) for the Uu interface in the non-split gNB and DRB.PacketSuccessRateUlUu.SNSSAI is the measurement that provides the fraction of PDCP SDU packets that are successfully received at the gNB. It is a measure of the UL packet delivery success including any packet success in the air interface & within the gNB. Only user-plane traffic (DTCH) and only PDCP SDUs that have entered PDCP (and given a PDCP sequence number) are considered. The measurement is optionally split into sub counters per QoS level (the mapped 5QI or QCI in NR option 3), and sub counters per supported S-NSSAI. This measurement is obtained as the number of successfully received UL PDCP sequence numbers, representing packets that are successfully delivered to higher layers, of a data radio bearer, divided by the total number of UL PDCP sequence numbers of a bearer, starting from the sequence number of the first packet delivered by the UE PDCP to the gNB until the sequence number of the last packet. Separate counters are optionally maintained for the mapped 5QI (or QCI for NR option 3) and per supported S-NSSAI. Each measurement is an integer value representing the success rate. The number of measurements is equal to one. If the optional QoS and S-NSSAI level measurements are performed, the measurements are equal to the number of the mapped 5QIs or the number of supported S-NSSAIs.

Reliability calculation for the non-split gNB (410) in the DL direction(s) (413) over the Uu interface (414): which will be done using the same methodology as defined for the split gNB in the above clause. It is represented by PSR DL, Uu, Split.

The reliability over the N3 interface (415): which can be determined in both UL direction(s) (416) and DL direction(s) (419). Depending on the measurement type used, there are two possible alternatives to determine the reliability over the N3 interface.

The reliability over the N3 interface (415) in the UL direction(s) (416): P_{URLLC,Reliability}, PSR is obtained for the N3 interface by using PSR % as given by below equation, which is based on the number of GTP data packets measurement (417).

$$Equation ( 10 )$$

$$PSR \% = {PSR}_{UL , N 3} = ( \frac{GTP . InDataPktN 3 UPF . SNSSAI}{\begin{matrix}GTP . InDataPktN 3 UPF . SNSSAI + \\ GTP . InDataPktPacketLossN 3 UPF . SNSSAI\end{matrix}} ) \times 100. \qquad ( 10 )$$

Where, the PSR_{UL,N3} is the PSR % in the UL direction(s) (416) for the N3 interface. The GTP.InDataPktPacketLossN3UPF.SNSSAI is the number of incoming GTP data packets that are lost over the N3 interface and not received successfully by the UPF. It is measured per the S-NSSAI sub-counter. The GTP.InDataPktN3UPF.SNSSAI is the number of GTP data PDUs on the N3 interface which have been accepted and successfully processed by the GTP-U protocol entity in the UPF. It is measured per the S-NSSAI sub-counter. These are as defined in 3GPP TS 28.552. However, the present disclosure requires these measurements to be generated per S-NSSAI.

The reliability over the N3 interface (415) in the UL direction(s) (416): PURLLC, Reliability, PSR is obtained for the N3 interface by using PSR % as given by the below equation, which is based on the number of octets of GTP data packets measurement (418).

$$Equation ( 11 )$$

$$PSR \% = {PSR}_{UL , N 3} = ( \frac{GTP . InDataOctN 3 UPF . SNSSAI}{\begin{matrix}GTP . InDataOctN 3 UPF . SNSSAI + \\ GTP . InDataOctetLossN 3 UPF . SNSSAI\end{matrix}} ) \times 100. \qquad ( 11 )$$

Where, PSR_{UL,N3} is the PSR % in the UL direction(s) (416) for the N3 interface (415). The GTP.InDataOctetLossN3UPF.SNSSAI is the number of incoming octets of GTP data packets that are lost over the N3 interface and not received successfully by UPF. It is measured per the S-NSSAI sub-counter. This measurement provides the number of octets of lost GTP data packets on the N3 interface which is not successfully received by the UPF. The measurement can be split into sub counters per S-NSSAI. This measurement is obtained by counting octets that belong to missing incoming GTP sequence numbers (3GPP TS 29.281) among all GTP packets delivered by the gNB to a UPF interface. A separate sub-counter is maintained for each SNSSAI. Each measurement is an integer value representing the number of octets of the lost GTP data packets. If the optional S-NSSAI sub-counter measurements are performed, the number of measurements is equal to the number of supported S-NSSAIs. GTP.InDataOctN3UPF.SNSSAI is the number of octets of GTP data packets over the N3 interface which have been accepted and successfully processed by the GTP-U protocol entity in the UPF. Which is measured per S-NSSAI sub-counter, which is as defined in 3GPP TS 28.552.

The reliability over the N3 interface (415) in the DL direction(s) (419): -PURLLC, Reliability, PSR is obtained for the N3 interface by using PSR % is given by the below equation, based on the number of GTP data packets measurement (420).

$$Equation ( 12 )$$

$$PSR \% = {PSR}_{DL , N 3} = ( \frac{\begin{matrix}GTP . OutDataPktN 3 UPF . SNSSAI - \\ GTP . InDataPktPacketLossN 3 gNB . SNSSAI\end{matrix}}{GTP . OutDataPktN 3 UPF . SNSSAI} ) \times 100. \qquad ( 12 )$$

Where, PSR_{DL,N3} is the PSR % in the DL direction(s) for the N3 interface. The GTP.OutDataPktN3UPF.SNSSAI is the number of GTP data PDUs on the N3 interface (415) that have been generated by the GTP-U protocol entity in the UPF. It is measured per the S-NSSAI sub-counter. The GTP.InDataPktPacketLossN3gNB.SNSSAI is the number of GTP data packets that are not successfully received at the gNB over the N3 interface (415) after being transmitted by the UPF. Which is measured per S-NSSAI sub-counter. These are defined in 3GPP TS 28.552. However, the present disclosure requires these measurements to be generated per S-NSSAI.

The reliability over the N3 interface (415) in the DL direction(s) (419): -PURLLC, Reliability, PSR is obtained for the N3 interface by using PSR % is given by the below equation, based on the number of octets of GTP data packets measurement (421).

$$Equation ( 13 ) .$$

$$PSR \% = {PSR}_{DL , N 3} = ( \frac{( GTP \cdot OutDataOctN 3 UPF \cdot SNSSAI - GTP \cdot InDataOctetLossN 3 gNB \cdot SNSSAI )}{( GTP \cdot OutDataOctN 3 UPF \cdot SNSSAI )} ) \times 100 \qquad ( 13 )$$

Where, PSR_{DL,N3} is the PSR % in the DL direction(s) for the N3 interface (415). The GTP.InDataOctetLossN3gNB.SNSSAI is the number of octets of GTP data packets that are not successfully received at the gNB over the N3 interface (415) after being transmitted by the UPF. It is measured per the S-NSSAI sub-counter. This measurement provides the number of octets of lost GTP data packets on the N3 interface (415) which are not successfully received by the gNB. The measurement can be split into sub counters per S-NSSAI. The measurement is obtained by counting octets that belong to missing incoming GTP sequence numbers (3GPP TS 29.281) among all GTP packets delivered by the UPF to a gNB interface. The separate sub-counter is maintained for each SNSSAI. Each measurement is an integer value representing the number of octets of the lost GTP data packets. If the optional S-NSSAI sub-counter measurements are performed, the number of measurements is equal to the number of supported S-NSSAIs. GTP.OutDataOctN3UPF.SNSSAI is the number of octets of outgoing GTP data packets on the N3 interface which have been generated by the GTP-U protocol entity in UPF. It is measured per S-NSSAI sub-counter, which is defined in 3GPP TS 28.552.

Method-2: at 422, the reliability performance based on the MTBF, in the context of communication service, reliability performance can be quantified using appropriate measures such as mean time between failures, or the probability of no failure within the specified period of time. The MTBF states the mean value of how long the communication service is available before it becomes unavailable. For instance, a mean time between failures of one month indicates that a communication service runs error-free for one month on average before error/errors make the communication service unavailable. So in this case, the reliability performance of the URLLC network slice i.e. PURLLC, Reliability is given by the MTBF and is denoted by PURLLC, Reliability, MTBF, is given by the below equation,

$$Equation ( 14 ) .$$

$${P}_{URLLC , Reliability} = {P}_{URLLC , Reliability , MTBF} \qquad ( 14 )$$

The reliability performance PURLLC, Reliability, MTBF is obtained by the measurement “MTBF.SNSSAI” which gives the average time between failures of slice/service i.e. the mean time period for which the service/slice remains available before it becomes unavailable. This is measured per SNSSAL. It can be in a number of days or hours or seconds. This measurement is exposed by the performance management service responsible for the performance of the slice/service.

If P_{URLLC,Reliability,MTBF is divided by the energy consumption of the network slice (ECNS) which is measured for the given time period equal to MTBF.SNSSAI i.e. for which the service remains available then we get EE KPI i.e. EEURLLC, Reliability, which essentially tells that “the reliability of the URLLC network slice/service, is a number of days/hours/seconds per joule of energy consumption”, the EEURLLC, Reliability of a URLLC slice can have the unit of days or hours or seconds per joule. The EE KPI is given by the below equation,}

$$Equation ( 15 ) .$$

$${EE}_{URLLC , Reliability} = \frac{MTBF \cdot SNSSAI}{{EC}_{NS}} \qquad ( 15 )$$

In an embodiment, the proposed method for assessing of the URLLC network slice in terms of its energy efficiency will be more accurate as it will be possible to consider the reliability of the network slice for the same. The reliability is considered in both ways i.e. the PSR % and the MTBF, so that makes the EE KPI even more comprehensive and accurate. Which will be possible for the network operator(s) to take better network optimization and planning decisions. Which will also be very useful for vertical customers which use a network operator's URLLC slice for various critical services like cyber-physical control application having periodic deterministic communication, V2X Services etc. The network operators also get methods to assess the PSR % over various interfaces as per their implementation choice in their network.

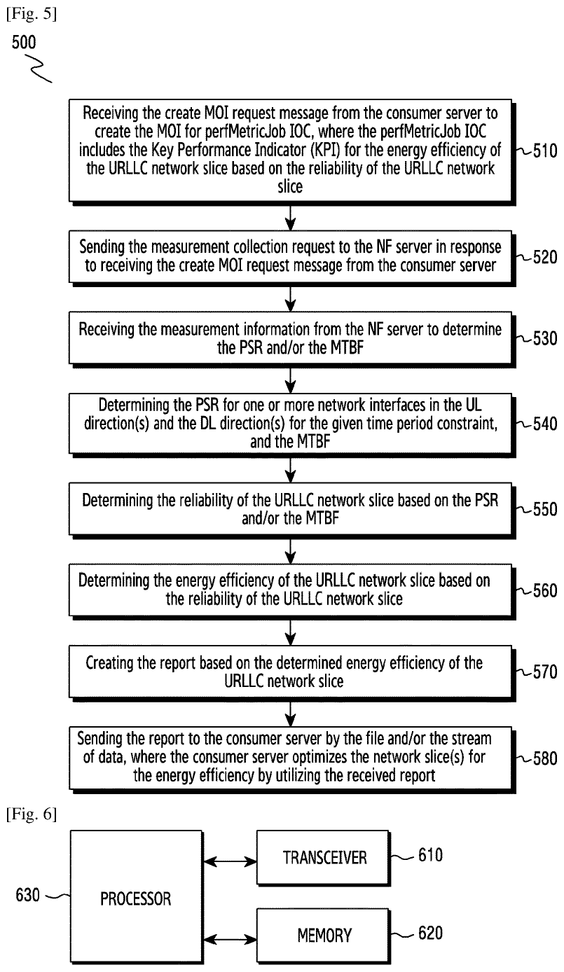

FIG. 5 is a flow diagram (500) illustrating a method for determining the energy efficiency of the URLLC network slice based on the reliability, according to an embodiment as disclosed herein.

At step 510, the method includes receiving the create MOI request message from the consumer server (200) to create the MOI for perfMetricJob IOC, where the perfMetricJob IOC includes the Key Performance Indicator (KPI) for the energy efficiency of the URLLC network slice based on the reliability of the URLLC network slice. At step 520, the method includes sending the measurement collection request to the NF server (300) in response to receiving the create MOI request message from the consumer server (200). At step 530, the method includes receiving the measurement information from the NF server (300) to determine the PSR and/or the MTBF. At step 540, the method includes determining the PSR for one or more network interfaces in the UL direction(s) and/or the DL direction(s) for the given time period constraint, and/or the MTBF. At step 550, the method includes determining the reliability of the URLLC network slice based on the PSR and/or the MTBF.

At step 560, the method includes determining the energy efficiency of the URLLC network slice based on the reliability of the URLLC network slice. At step 570, the method includes creating the report based on the determined energy efficiency of the URLLC network slice. At step 580, the method includes sending the report to the consumer server (200) by the file and/or the stream of data, where the consumer server (200) optimizes the URLLC network slice (s) for the energy efficiency by utilizing the received report.

FIG. 6 is a block diagram of an internal configuration of a UE, according to an embodiment.

As shown in FIG. 6, the UE according to an embodiment may include a transceiver 610, a memory 620, and a processor 630. The transceiver 610, the memory 620, and the processor 630 of the UE may operate according to a communication method of the UE described above. However, the components of the UE are not limited thereto. For example, the UE may include more or fewer components than those described above. In addition, the processor 630, the transceiver 610, and the memory 620 may be implemented as a single chip. Also, the processor 630 may include at least one processor.

The transceiver 610 collectively refers to a UE receiver and a UE transmitter, and may transmit/receive a signal to/from a base station or a network entity. The signal transmitted or received to or from the base station or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the UE. Also, the memory 620 may store control information or data included in a signal obtained by the UE. The memory 620 may be a storage medium, such as read-only memory (ROM), random access memory (RAM), a hard disk, a CD-ROM, and a DVD, or a combination of storage media.

The processor 630 may control a series of processes such that the UE operates as described above. For example, the transceiver 610 may receive a data signal including a control signal transmitted by the base station or the network entity, and the processor 630 may determine a result of receiving the control signal and the data signal transmitted by the base station or the network entity.

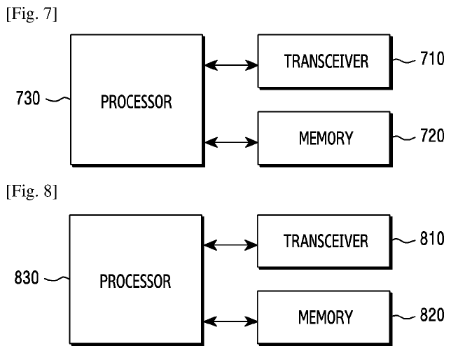

FIG. 7 is a block diagram of an internal configuration of a base station, according to an embodiment. Furthermore, the base station may correspond to gNB of FIG. 2A,

As shown in FIG. 7, the base station according to an embodiment may include a transceiver 710, a memory 720, and a processor 730. The transceiver 710, the memory 720, and the processor 730 of the base station may operate according to a communication method of the base station described above. However, the components of the base station are not limited thereto. For example, the base station may include more or fewer components than those described above. In addition, the processor 730, the transceiver 710, and the memory 720 may be implemented as a single chip. Also, the processor 730 may include at least one processor.

The transceiver 710 collectively refers to a base station receiver and a base station transmitter, and may transmit/receive a signal to/from a terminal or a network entity. The signal transmitted or received to or from the terminal or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the base station. Also, the memory 720 may store control information or data included in a signal obtained by the base station. The memory 720 may be a storage medium, such as read-only memory (ROM), random access memory (RAM), a hard disk, a CD-ROM, and a DVD, or a combination of storage media.

The processor 730 may control a series of processes such that the base station operates as described above. For example, the transceiver 710 may receive a data signal including a control signal transmitted by the terminal, and the processor 730 may determine a result of receiving the control signal and the data signal transmitted by the terminal.

FIG. 8 is a block diagram showing an internal structure of a network entity, according to an embodiment of the present disclosure. Furthermore, the base station may correspond to gNB of FIG. 2B,

As shown in FIG. 8, the network entity of the present disclosure may include a transceiver 810, a memory 820, and a processor 830. The transceiver 810, the memory 820, and the processor 830 of the network entity may operate according to a communication method of the network entity described above. However, the components of the terminal are not limited thereto. For example, the network entity may include more or fewer components than those described above. In addition, the processor 1230, the transceiver 810, and the memory 820 may be implemented as a single chip. Also, the processor 830 may include at least one processor.

The transceiver 810 collectively refers to a network entity receiver and a network entity transmitter, and may transmit/receive a signal to/from a base station or a UE. The signal transmitted or received to or from the base station or the UE may include control information and data. In this regard, the transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the network entity. Also, the memory 820 may store control information or data included in a signal obtained by the network entity. The memory 820 may be a storage medium, such as ROM, RAM, a hard disk, a CD-ROM, and a DVD, or a combination of storage media.

The processor 830 may control a series of processes such that the network entity operates as described above. For example, the transceiver 810 may receive a data signal including a control signal, and the processor 830 may determine a result of receiving the data signal.

Accordingly, the embodiment herein is to provide a method for determining an energy efficiency of an Ultra-Reliable Low Latency Communications (URLLC) network slice based on reliability in a wireless communication system. The method includes determining, by a producer server (100), a Packet Success Rate (PSR) for one or more network interfaces in at least one of an Uplink (UL) direction and a Down Link (DL) direction for a given time period constraint, and a Mean Time Between Failures (MTBF) in a network. Further, the method includes determining, by the producer server (100), a reliability of the URLLC network slice based on at least one of the PSR and the MTBF. Further, the method includes determining, by the producer server (100), the energy efficiency of the URLLC network slice based on the reliability of the URLLC network slice.

In an embodiment, the method includes determining the PSR for one or more network interfaces in the at least one of the UL direction and the DL direction for the given time period constraint comprises at least one of determining, by the producer server (100), the PSR over a Uu Interface in at least one of the DL direction for a split gNB, the UL direction for a non-split gNB, and the DL direction for the non-split gNB, determining, by the producer server (100), the PSR over a F1-U Interface in at least one of the UL direction and the DL direction for the split gNB, determining, by the producer server (100), the PSR over the Uu interface including gNB Centralized Unit (gNB-CU) and the F1-U interface in the UL direction for the split gNB, determining, by the producer server (100), a number of outgoing GPRS Tunnelling Protocol (GTP) data packets on an N3 interface from a User Plane Function (UPF) per Single-Network Slice Selection Assistance Information (S-NSSAI) sub-counter, determining, by the producer server (100), a number of incoming GTP data packets loss on the N3 interface in a gNB per the S-NSSAI sub-counter, determining, by the producer server (100), a number of incoming GTP data packets loss on the N3 interface in the UPF per the S-NSSAI sub-counter, determining, by the producer server (100), a number of GTP data packets on the N3 interface, wherein the number of GTP data packets have been accepted and successfully processed by a GTP-U protocol entity in the UPF per the S-NSSAI sub-counter, determining, by the producer server (100), a number of octets of GTP data packets, wherein the number of octets of GTP data packets are not successfully received at the gNB over the N3 interface after being transmitted by the UPF per the S-NSSAI sub-counter, and determining, by the producer server (100), a number of octets of GTP data packets loss on the N3 interface in the UPF per the S-NSSAI sub-counter.

In an embodiment, the producer server determines the average MTBF of the URLLC network slice/service that indicates a time period wherein the URLLC network slice/service remains available before becoming unavailable as a per S-NSSAI sub-counter.

In an embodiment, the method includes determining, by the producer server (100), the reliability of the URLLC network slice based on at least one of the PSR and the MTBF comprises: determining, by the producer server (100), the at least one of the PSR and the MTBF to determine the reliability of the URLLC network slice based on at least one of a type of service and a type of a slice of the network. Further, the method includes performing, by the producer server (100), at least one of: determining the reliability of the URLLC network slice based on the determined PSR, determining the reliability of the URLLC network slice based on the determined MTBF, and determining the reliability of the URLLC network slice based on the selected PSR and the selected MTBF.

In an embodiment, the method includes determining, by the producer server (100), the energy efficiency of the URLLC network slice based on the reliability comprises: determining, by the producer server (100), a total amount of energy consumption of the URLLC network slice for the given time period constraint and determining, by the producer server (100), the energy efficiency of the URLLC network slice based on the reliability and the total amount of energy consumption.

In an embodiment, the method includes receiving, by the producer server (100), a create Managed Object Instance (MOI) request message from a consumer server (200) to create a MOI for perfMetricJob IOC, wherein the perfMetricJob IOC comprises a Key Performance Indicator (KPI) for energy efficiency of the URLLC network slice based on the reliability of the URLLC network slice. Further, the method includes sending, by the producer server (100), a measurement collection request to a Network Function (NF) server (300) in response to receiving the create MOI request message from the consumer server (200) and Further, the method includes receiving, by the producer server (100), measurement information from the NF server (300) to determine the at least one of the PSR and the MTBF. further, the method includes creating, by the producer server (100), a report based on the determined energy efficiency and further, the method includes sending, by the producer server (100), the report to the consumer server (200) by at least one of a file and a stream of data, wherein the consumer server (200) optimizes at least one URLLC network slice for the energy efficiency by utilizing the received report.

In an embodiment, the method includes sending, by the consumer server (200), a create Manage Object Instance (MOI) request message to the producer server (100) to create the MOI. Further, the method includes receiving, by the consumer server (200), a response message from the producer server (100) in response to sending the create MOI request message. Further, the method includes receiving, by the consumer server (200), a report from the producer server (100) by at least one of a file and a stream data. And further, the method includes optimizing, by the consumer server (200), at least one URLLC network slice for the energy efficiency by utilizing the received report.

Accordingly, the embodiment herein is to provide a method for optimizing at least one of an Ultra-Reliable Low Latency Communications (URLLC) network slice for an energy efficiency. The method includes sending, by a consumer server (200), a create Manage Object Instance (MOI) request message to a producer server (100) to create a MOI. further, the method includes receiving, by the consumer server (200), a response message from the producer server (100) in response to sending the create MOI request message. further, the method includes receiving, by the consumer server (200), a report from the producer server (100) by at least one of a file and a stream data, wherein the report comprises an energy efficiency of the URLLC network slice based on a reliability. And further, the method includes optimizing, by the consumer server (200), the at least one URLLC network slice for the energy efficiency by utilizing the received report.

Accordingly, the embodiment herein is to provide a producer server (100) for determining an energy efficiency of an Ultra-Reliable Low Latency Communications (URLLC) network slice based on reliability. The producer server (100) comprises a memory (1100), a processor (120), and an URLLC network slice controller (140), operably connected to the memory (110). and the processor (120), configured to determine a Packet Success Rate (PSR) for one or more network interfaces in at least one of an Uplink (UL) direction and a Down Link (DL) direction for a given time period constraint, and a Mean Time Between Failures (MTBF) in a network. Further, the processor (120) configured to determine a reliability of the URLLC network slice based on at least one of the PSR and the MTBF. And further, the processor (120) configured to determine the energy efficiency of the URLLC network slice based on the reliability of the URLLC network slice.

In an embodiment, the producer server (100) as claimed in claim 10, wherein determine the PSR for one or more network interfaces in the at least one of the UL direction and the DL direction for the given time period constraint comprises at least one of: determine the PSR over a Uu Interface in at least one of the DL direction for a split gNodeB, the UL direction for a non-split gNB, and the DL direction for the non-split gNB, determine the PSR over a F1-U Interface in at least one of the UL direction and the DL direction for the split gNB, determine the PSR over the Uu interface including gNodeB Centralized Unit (gNB-CU) and the F1-U interface in the UL direction for the split gNB, determine a number of outgoing GPRS Tunnelling Protocol (GTP) data packets on an N3 interface from a User Plane Function (UPF) per Single-Network Slice Selection Assistance Information (S-NSSAI) sub-counter, determine a number of incoming GTP data packets loss on the N3 interface in the gNB per the S-NSSAI sub-counter, determine a number of incoming GTP data packets loss on the N3 interface in the UPF per the S-NSSAI sub-counter, determine a number of GTP data packets on the N3 interface, wherein the number of GTP data packets have been accepted and successfully processed by the GTP-U protocol entity in the UPF per the S-NSSAI sub-counter, determine a number of octets of GTP data packets, wherein the number of octets of GTP data packets are not successfully received at the gNB over the N3 interface after being transmitted by the UPF per the S-NSSAI sub-counter, and determine a number of octets of GTP data packets loss on the N3 interface in the UPF per the S-NSSAI sub-counter.

In an embodiment, the producer server (100) determines the average MTBF of the URLLC network slice/service that indicates a time period wherein the URLLC network slice/service remains available before becoming unavailable as a per S-NSSAI sub-counter.

In an embodiment, the producer server (100) determines the reliability of the URLLC network slice based on at least one of the PSR. the MTBF comprises: determine the at least one of the PSR and the MTBF to determine the reliability of the URLLC network slice based on at least one of a type of service and a type of a slice of the network, perform at least one of: determining the reliability of the URLLC network slice based on the determined PSR, and determining the reliability of the URLLC network slice based on the determined MTBF, and determining the reliability of the URLLC network slice based on the selected PSR and the selected MTBF. further, the producer server determines the energy efficiency of the URLLC network slice based on the reliability. the producer comprises determine a total amount of energy consumption of the URLLC network slice for the given time period constraint and determine the energy efficiency of the URLLC network slice based on the reliability and the total amount of energy consumption.

In an embodiment, the URLLC network slice controller (140) is configured to receive a create Manage Object Instance (MOI) request message from a consumer server (200) to create a MOI for perfMetricJob IOC, wherein the perfMetricJob IOC comprises a Key Performance Indicator (KPI) for energy efficiency of the URLLC network slice based on the reliability of the URLLC network slice. the URLLC network slice controller (140) is configured to send a measurement collection request to a Network Function (NF) server (300) in response to receiving the create MOI request message from the consumer server (200). the URLLC network slice controller (140) is configured to receive measurement information from the NF server (300) to determine the at least one of the PSR and the MTBF.

In an embodiment, the URLLC network slice controller (140) is configured to create a report based on the determined energy efficiency of the URLLC network slice. the URLLC network slice controller (140) is configured to send the report to the consumer server (200) by at least one of a file and a stream of data, wherein the consumer server (200) optimizes at least one URLLC network slice for the energy efficiency by utilizing the received report.

Accordingly, the embodiment herein is to provide a consumer server (200) optimizing at least one of an Ultra-Reliable Low Latency Communications (URLLC) network slice for an energy efficiency. the consumer server (200) comprising a memory (210), a processor (220), and an URLLC network slice controller (240), operably connected to the memory (210). The processor (220) configured to send a create Manage Object Instance (MOI) request message to a producer server (100) to create a MOI. Further the processor (220) configured to receive a response message from the producer server (100) in response to sending the create MOI request message. Further the processor (220) configured to receive a report from the producer server (100) by at least one of a file and a stream data, wherein the report comprises an energy efficiency of the URLLC network slice based on its reliability. Further the processor (220) configured to optimize the at least one URLLC network slice for the energy efficiency by utilizing the received report.

The various actions, acts, blocks, steps, or the like in the flow diagram (400 and 500) may be performed in the order presented, in a different order, or simultaneously. Further, in some embodiments, some of the actions, acts, blocks, steps, or the like may be omitted, added, modified, skipped, or the like without departing from the scope of the disclosure.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a first node in a wireless communication system, the method comprising:
identifying a packet success rate (PSR) for a network interface from the first node to a second node, the PSR indicating a percentage value of a number of network packets successfully delivered to the second node divided by a total number of packets; and
identifying a reliability key performance indicator (KPI) per a single network slice selection assistance information (S-NSSAI) based on the PSR.

17. The method of claim 16, wherein in case that the first node is a base station (BS) and the second node is a user equipment (UE), the reliability KPI for the network interface is identified as follows:
$$⌊ \frac{N ( T 1 , drbid ) \cdot SNSSAI}{N ( T 1 , drbid ) \cdot SNSSAI + Dloss ( T 1 , drbid ) \cdot SNSSAI} ⌋ * 100 ,$$
wherein the drbid is identity of the measured data radio bearer (DRB),
wherein the N(T1, drbid) is a number of downlink (DL) packets of a DRB with the drbid per the S-NSSAI, which is transmitted successfully during a time period T1, and
wherein the Dloss(T1, drbid) is a number of DL packets of a DRB with the drbid per the S-NSSAI, which is transmitted not successfully during the time period T1.

18. The method of claim 16, wherein in case that the first node is a user equipment (UE) and the second node is a base station (BS), the reliability KPI for the network interface is identified as follows:
$$DRB \cdot PacketSuccessRateU 1 gNBUu \cdot SNSSAI * 100 ,$$
wherein the DRB.PacketSuccessRateUlUu.SNSSAI is based on a fraction of packet data convergent protocol (PDCP) service data units (SDUs) which are transmitted successfully to the BS.

19. The method of claim 18, wherein DRB.PacketSuccessRateUlgNBUu.SNSSAI is identified based on user-plane traffic and PDCP SDUs entered PDCP, and
wherein the DRB.PacketSuccessRateUlgNBUu.SNSSAI is identified based on subcounters per the QoS level and subcounters per supported S-NSSAI.

20. The method of claim 16, wherein in case that the first node is a user plane function (UPF) entity and the second node is a base station (BS), the reliability KPI for the network interface is identified as follow:
$$( \frac{GTP \cdot OutDataPktN 3 UPF \cdot SNSSAI - GTP \cdot InDataPktPacketLossN 3 gNB \cdot SNSSAI}{GTP \cdot OutDataPktN 3 UPF \cdot SNSSAI} ) \times 100 ,$$
wherein the GTP.OutDataPktN3UPF.SNSSAI is a number of general packet radio service (GPRS) tunneling protocol (GTP) data protocol data units (PDUs) on the network interface generated by a GTP-U protocol entity in the UPF entity, and
wherein the GTP.InDataPktPacketLossN3gNB.SNSSAI is a number of GTP data packets which are transmitted not successfully at the BS over the network interface.

21. The method of claim 16, wherein in case that the first node is a base station (BS) and the second node is a user plane function (UPF) entity, the reliability KPI for the network interface is identified as follows:
$$( \frac{GTP \cdot InDataPktN 3 UPF \cdot SNSSAI}{GTP \cdot OutDataPktN 3 UPF \cdot SNSSAI - GTP \cdot InDataPktPacketLossN 3 UPF \cdot SNSSAI} ) \times 100 ,$$
wherein the GTP.InDataPktN3UPF.SNSSAI is a number of GTP data PDUs on the network interface which is accepted and successfully processed by a GTP-U protocol entity in the UPF entity, and
wherein the GTP.InDataPktPacketLossN3UPF.SNSSAI is a number of incoming GTP data packets that are lost over the network interface and not received successfully by the UPF entity.

22. The method of claim 16, wherein in case that the first node is a centralized unit (CU) of a base station (BS) and the second node is a distributed unit (DU) of the BS, the reliability KPI for the network interface is identified as follows:
$$DRB \cdot F 1 UPacketSuccessRateDl \cdot SNSSAI * 100 ,$$
wherein the DRB.F1UPacketSuccessRateDl.SNSSAI is the measurement that provides the fraction of PDCP SDU packets that are successfully received at the gNB-DU.

23. The method of claim 16, wherein in case that the first node a centralized unit (CU) of a base station (BS) and the second node is a distributed unit (DU) of the BS, the reliability KPI for the network interface is identified as follows:
$$DRB \cdot F 1 UPacketSuccessRateUl \cdot SNSSAI \times 100 ,$$
wherein the DRB.PacketSuccessRateUlUu.SNSSAI is based on a fraction of PDCP SDUs which are transmitted successfully to the DU of the BS.

24. The method of claim 16, wherein the S-NSSAI is associated with an ultra-reliable low latency communication (URLLC).

25. The method of claim 16, further comprising identifying an energy efficiency (EE) based on the identified reliability KPI of the URLLC network slice.

26. A first node in a wireless communication system, the first node comprising:
a transceiver, and
a controller coupled with the transceiver and configured to:
identify a packet success rate (PSR) for a network interface from the first node to a second node, the PSR indicating a percentage value of a number of network packets successfully delivered to the second node divided by a total number of packets, and
identify reliability key performance indicator (KPI) per a single network slice selection assistance information (S-NSSAI) based on the PSR.

27. The first node of claim 26, wherein in case that the first node is a base station (BS) and the second node is a user equipment (UE), the reliability KPI for the network interface is identified as follows:
$$⌊ \frac{N ( T 1 , drbid ) \cdot SNSSAI}{N ( T 1 , drbid ) \cdot SNSSAI + Dloss ( T 1 , drbid ) \cdot SNSSAI} ⌋ * 100 ,$$
wherein the drbid is identity of the measured data radio bearer (DRB),
wherein the N (T1, drbid) is a number of downlink (DL) packets of a DRB with the drbid per the S-NSSAI, which is transmitted successfully during a time period T1, and
wherein the Dloss (T1, drbid) is a number of DL packets of a DRB with the drbid per the S-NSSAI, which is transmitted not successfully during the time period T1.

28. The first node of claim 26, wherein in case that the first node is a user equipment (UE) and the second node is a base station (BS), the reliability KPI for the network interface is identified as follows:
$$DRB \cdot PacketSuccessRateUlgNBUu \cdot SNSSAI * 100 ,$$
wherein the DRB.PacketSuccessRateUlUu.SNSSAI is based on a fraction of packet data convergent protocol (PDCP) service data units (SDUs) which are transmitted successfully to the BS.

29. The first node of claim 28, wherein DRB.PacketSuccessRateUlgNBUu.SNSSAI is identified based on user-plane traffic and PDCP SDUs entered PDCP, and
wherein the DRB.PacketSuccessRateUlgNBUu.SNSSAI is identified based on subcounters per the QoS level and subcounters per supported S-NSSAI.

30. The first node of claim 26, wherein in case that the first node is a user plane function (UPF) entity and the second node is a base station (BS), the reliability KPI for the network interface is identified as follows:
$$( \frac{GTP \cdot OutDataPktN 3 UPF \cdot SNSSAI - GTP \cdot InDataPktPacketLossN 3 gNB \cdot SNSSAI}{GTP \cdot OutDataPktN 3 UPF \cdot SNSSAI} ) \times 100 ,$$
wherein the GTP.OutDataPktN3UPF.SNSSAI is a number of general packet radio service (GPRS) tunneling protocol (GTP) data protocol data units (PDUs) on the network interface generated by a GTP-U protocol entity in the UPF entity, and
wherein the GTP.InDataPktPacketLossN3gNB.SNSSAI is a number of GTP data packets which are transmitted not successfully at the BS over the network interface.

31. The first node of claim 26, wherein in case that the first node is a base station (BS) and the second node is a user plane function (UPF) entity, the reliability KPI for the network interface is identified as follows:
$$( \frac{GTP \cdot InDataPktN 3 UPF \cdot SNSSAI}{GTP \cdot InDataPktN 3 UPF \cdot SNSSAI - GTP \cdot InDataPktPacketLossN 3 UPF \cdot SNSSAI} ) \times 100 ,$$
wherein the GTP.InDataPktN3UPF.SNSSAI is a number of GTP data PDUs on the network interface which is accepted and successfully processed by a GTP-U protocol entity in the UPF entity, and
wherein the GTP.InDataPktPacketLossN3UPF.SNSSAI is a number of incoming GTP data packets that are lost over the network interface and not received successfully by the UPF entity.

32. The first node of claim 26, wherein in case that the first node is a centralized unit (CU) of a base station (BS) and the second node is a distributed unit (DU) of the BS, the reliability KPI for the network interface is identified as follows:
$$DRB \cdot F 1 UPacketSuccessRateDl \cdot SNSSAI * 100 ,$$
wherein the DRB.F1UPacketSuccessRateDl.SNSSAI is the measurement that provides the fraction of PDCP SDU packets that are successfully received at the gNB-DU.

33. The first node of claim 26, wherein in case that the first node is a centralized unit (CU) of a base station (BS) and the second node is a distributed unit (DU) of the BS, the reliability KPI for the network interface is identified as follows:
$$DRB \cdot F 1 UPacketSuccessRateUl \cdot SNSSAI \times 100 ,$$
wherein the DRB.PacketSuccessRateUlUu.SNSSAI is based on a fraction of PDCP SDUs which are transmitted successfully to the DU of the BS.

34. The first node of claim 26, wherein the S-NSSAI is associated with an ultra-reliable low latency communication (URLLC).

35. The first node of claim 26, wherein the controller is further configured to identify an energy efficiency (EE) based on the identified reliability KPI of the URLLC network slice.
